(19) United States
(12) Patent Application Publication
(10) Pub. No.: US 2016/0375793 A1
(43) Pub. Date: Dec. 29, 2016

(54) Software-defined vehicular powertrain and method of operation

(71) Applicants: Shivinder Singh SIKAND, Santa Cruz, CA (US); Dean DRAKO, Austin, TX (US)

(72) Inventors: Shivinder Singh SIKAND, Santa Cruz, CA (US); Dean DRAKO, Austin, TX (US)

(21) Appl. No.: 14/809,246

(22) Filed: Jul. 26, 2015

Related U.S. Application Data
(60) Provisional application No. 62/185,796, filed on Jun. 29, 2015.

(51) Int. Cl. B60L 15/20; B60L 3/00; B60L 7/14; B60L 15/06; B60L 11/00

(52) U.S. Cl. CPC B60L 15/20; B60L 15/06; B60L 15/2045; B60L 11/00; B60L 7/14; B60L 3/00; B60L 2210/40; B60L 2220/46; B60L 2240/10; B60L 2240/423; B60L 2240/429

(57) ABSTRACT

A software-defined powertrain transmits commands to at least 4 distributed polyphase motor controllers. A single vehicle control unit transforms operator control indicia into a plurality of individual commands, and securely transmits said commands to each one of a plurality of independent motor controllers mechanically coupled to a single wheel by a polyphase electric motor. The motor controllers are DC to variable AC electrical converters which each receives phase and magnitude requirements. An operating system provides an encrypted application-programming interface to operate functions such as torque vectoring, cooling, braking, and battery management. The OS provides an isolating trust zone to each layer or application for authentication and validation. Upgrades are available to install new features or improvements after a vehicle is in the field. Independent developers may test and furnish new capabilities without exposing or corrupting the IP of other vehicle modalities.

### CROSS-REFERENCES TO RELATED APPLICATIONS

This non-provisional application benefits from Ser. No. 62185796 filed 29 Jun. 2015 which is incorporated,by reference in its entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

Technical Field

Vehicle control and torque distribution.

Description of the Related Art

As is known, (Faccioli of Schenectady N.Y., U.S. Pat. No. 949,320 February 1910) “Variable-Frequency Generators . . . to provide a self-exciting alternating-current . . . at frequencies which may be varied over a wide range . . . finds a useful application in supplying current to induction motors for driving cars, locomotives, or other mechanisms which are to be driven at variable speeds.”

Vector control and direct torque control (DTC), adjust the motor voltage magnitude, angle from reference, and frequency so as to precisely control the motor's magnetic flux and mechanical torque.

### BRIEF SUMMARY OF THE INVENTION

A software-defined powertrain transmits commands to at least 4 distributed polyphase motor controllers. A single vehicle control unit transforms operator control indicia into a plurality of individual commands, and securely transmits said commands to each independent motor controller mechanically coupled to a single wheel by a polyphase electric motor. The motor controllers are DC to variable AC electrical converters which each receives phase and magnitude requirements.

A system for operation of a vehicle having at least 4 inverters; each inverter coupled to, an energy store; the energy store and each inverter further coupled to, a single vehicle control unit (VCU); the VCU further coupled to both, an operator control interface circuit; and a plurality of sensors.

The VCU is a computer adapted to emit either a desired torque, or alternately, a desired AC current frequency and magnitude for each inverter by transforming indicia received from at least one sensor and from the operator control interface.

The software-defined powertrain enables a vehicle subsystem to be independently improved without interfering with the operation of other subsystems.

A real time Ethernet backbone couples a plurality of local client hubs to a single vehicle control unit. Each client hub only has an encryption/decryption engine, and a PHY modem coupled to a layer 2 Ethernet interface. The vehicle control unit creates a trust zone for each app and manages traffic across the backbone. Non-trivial computing is performed by a central containerized platform. This includes diagnostics for failures as well as malicious intrusion detection.

A single vehicle control unit transforms operator control indicia into a plurality of individual commands, and securely transmits said commands to actuators and control devices. An operating system provides an encrypted application-programming interface to operate functions such as torque vectoring, cooling, braking, and battery management. The OS provides an isolating trust zone to each layer or application for authentication and validation. Upgrades are available to install new features or improvements after a vehicle is in the field.

### BRIEF DESCRIPTION OF THE SEVERAL VIEWS OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1-2 are system block diagrams of components in a vehicle control system;

FIG. 3-4 is a data flow diagram of components in a secure network; and

FIG. 5 -6 is a block diagram of software components shown as a rotated stack.

### DETAILED DISCLOSURE OF EMBODIMENTS OF THE INVENTION

Selectable software defined powertrain modules determine responsiveness of a vehicle to its operator influences. All handling aspects reflect centrally stored parameters that affect each wheel separately.

A single vehicle control unit transforms operator control indicia into a plurality of individual commands, and securely transmits said commands to each one of a plurality of independent motor controllers mechanically coupled to a single wheel by a polyphase electric motor.

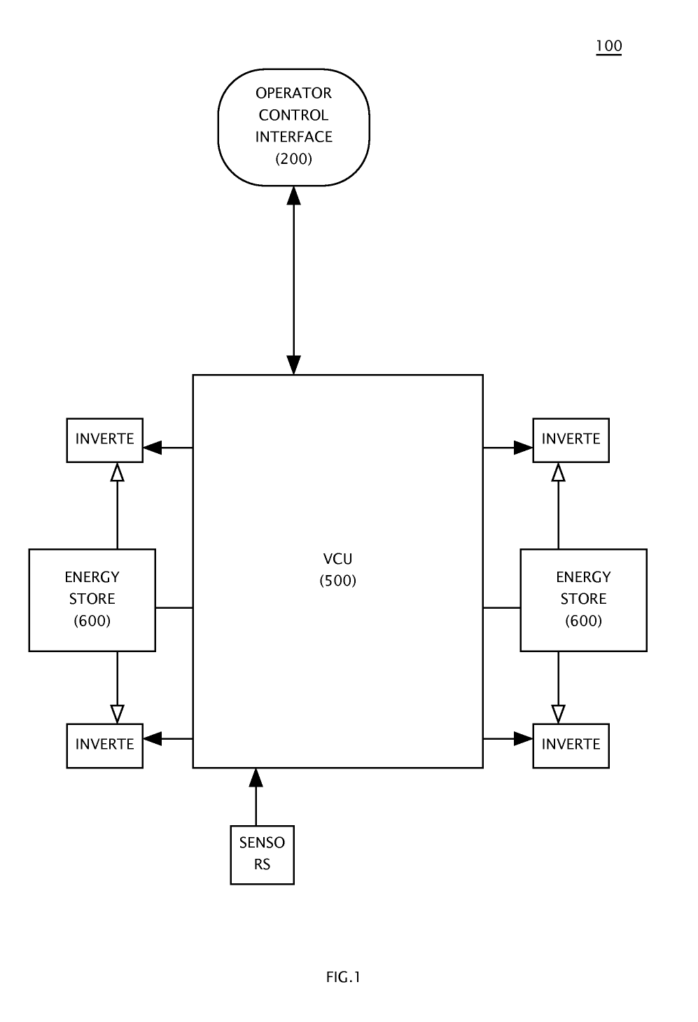

Referring now to FIG. 1: A system 100 for operation of a vehicle, includes at least 4 inverters 701-704; each inverter coupled to, an energy store 600; the energy store and each inverter further coupled to, a single vehicle control unit (VCU) 500; the VCU further coupled to both, an operator control interface circuit (200); and a plurality of sensors (300).

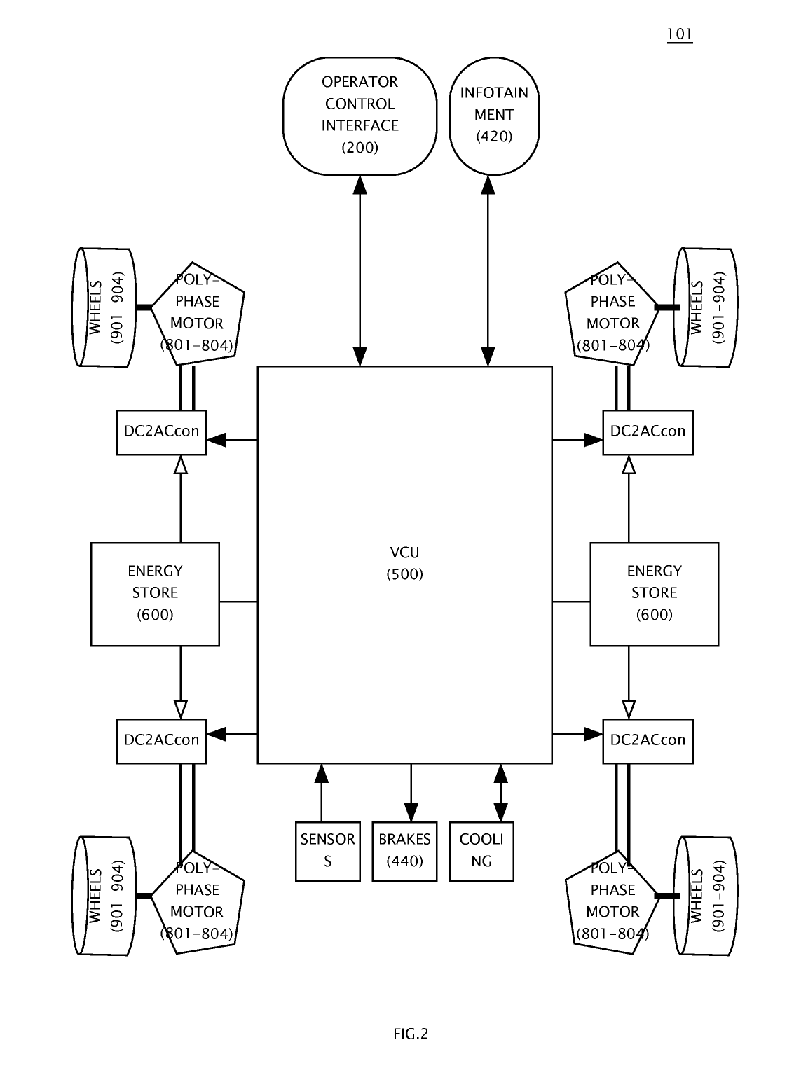

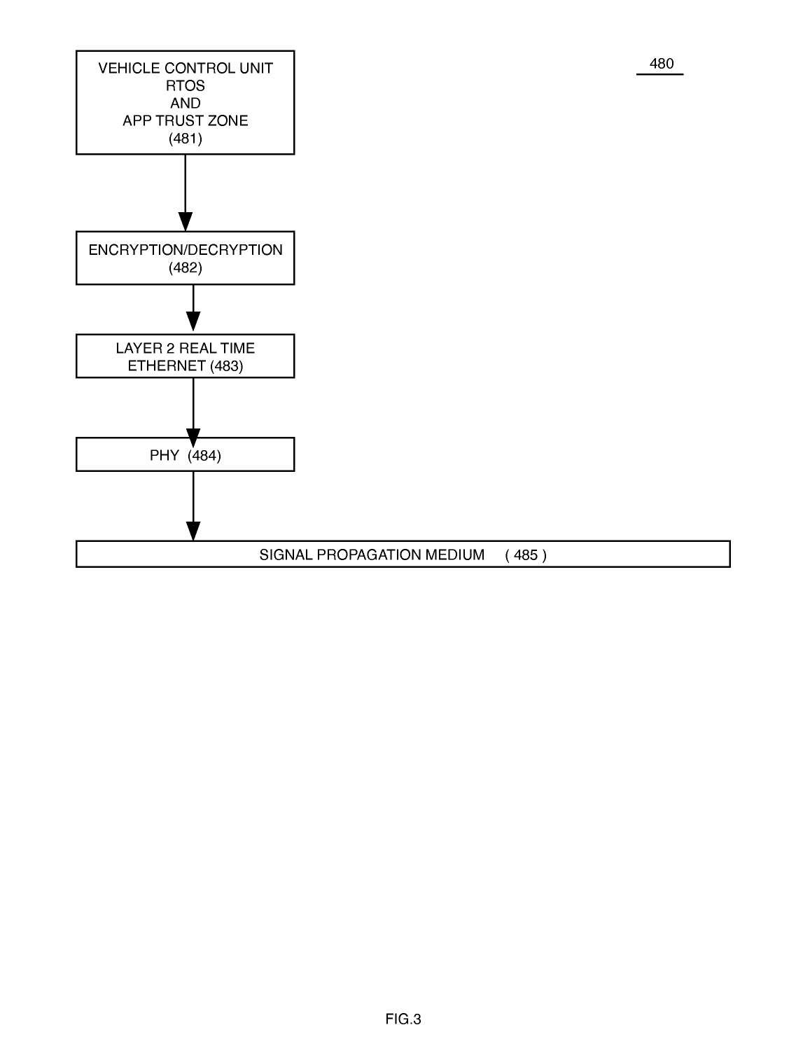

The four or more motor controllers are DC to variable AC electrical converters which each receives phase and magnitude requirements. Referring now to FIG. 2 in an embodiment, 101 each of the four or more inverters is a DC to AC converter 705-708; each said DC to AC converter coupled to a polyphase electric motor 801-804 which propels an individual wheel 901-904.

To address the congestion and security challenges of conventional CAN bus technology, the present invention provides a secure real time Ethernet channel. Referring now to FIG. 3, an exemplary secure vehicle control network 480 includes a medium 485; the medium coupled to, a PHY circuit 484; the PHY circuit coupled to, a layer 2 real time Ethernet circuit controller 483; coupled to an encryption/decryption circuit (coder) 482; and, the coder coupled to, a vehicle control unit 481 comprising a processor performing a real time operating system and trust zone layer.

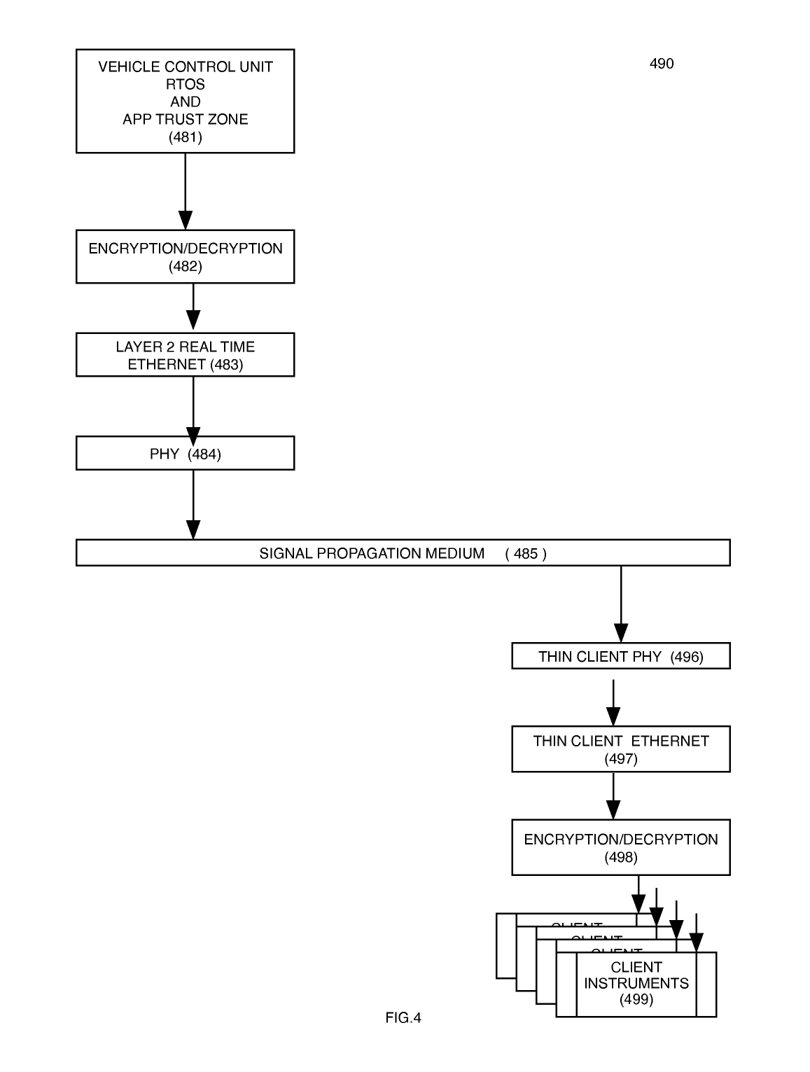

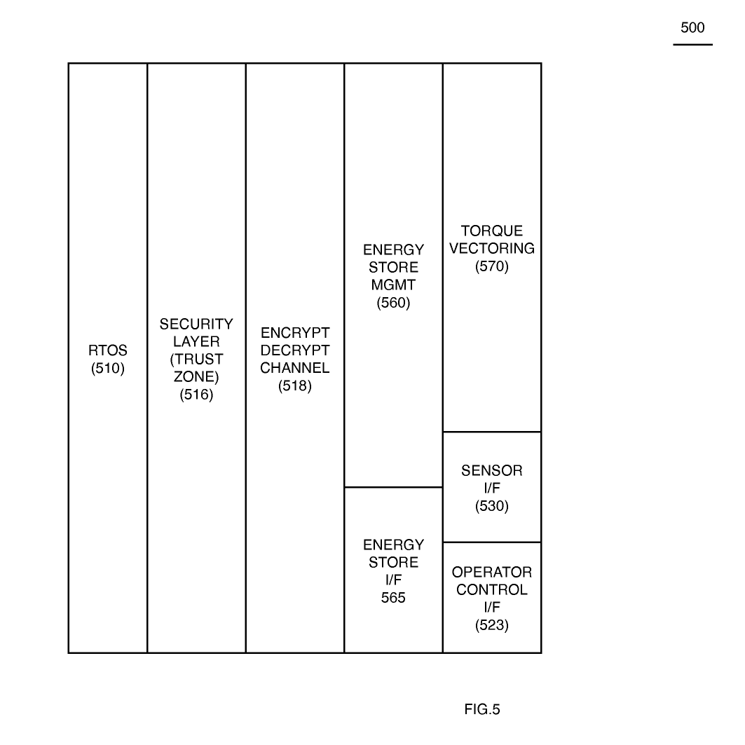

Referring now to FIG. 4, the secure vehicle control network 490 also includes a thin client PHY circuit 496; the PHY coupled to the signal propagation medium; and to, a thin client Ethernet remote node 497; and, an encryption/decryption circuit (coder) 498, for connection to at least one client instrument 499.

An operating system provides an encrypted application-programming interface to operate functions such as torque vectoring, cooling, braking, and battery management. In embodiments, the system also includes Electronic ABS circuit; Stability Control circuit; Brake force distribution; and a Regenerative braking circuit.

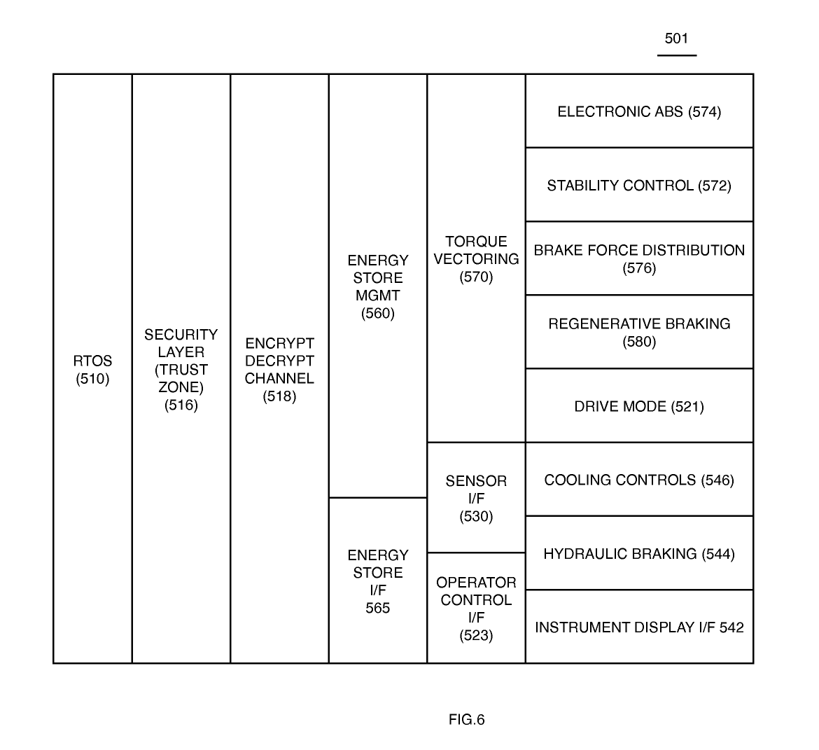

The OS provides an isolating trust zone to each layer or application for authentication and validation. Referring now to FIG. 5, a modular vehicle control unit 500 includes a processor coupled to a non-transitory instruction store, which performs a real time operating system (RTOS) 510; a security layer to provide at least one trust zone 516; an encryption/decryption channel to transmit and receive data and controls over a secure vehicle control network; an energy store management module 560; an energy store interface 565; an operator control interface 523; a sensor interface 530; and a torque vectoring module 570.

With the new modularity, upgrades are available to install new features or improvements asynchronously from a vehicle product cycle.

Referring now to FIG.6, the modular vehicle control unit also includes 580 Regenerative braking—all 4 wheels for regen braking; 576 Brake Force Distribution—Electronic Stability Control in some circles; 574 Electronic ABS—this is the ABS logic for braking that uses the electric motors; 572 Stability Control—to dampen oscillations due to driver overcorrection; 546 Cooling Interface—connections to the battery, inverters, and other systems; 544 Hydraulic Braking Interface—interface to the hydraulic braking system for monitoring and knowing when engaged; Instrument Display Interface 542—outputs to the Infotainment display system, covers all systems; Drive Mode Inputs 521—Settings from the driver on the style of driving and settings; wherein the Sensor Interface receives measured Motion, Accelerometers, and wheel spin sensor inputs.

In an embodiment, the system also includes Drive Mode circuit set within the operator control; Cooling control circuits 460; Hydraulic braking circuit 440; and an Instrument display interface 420.

Independent developers may test and furnish new capabilities without exposing or corrupting the IP of other vehicle modalities.

In an embodiment, the indicia received from the at least one sensor is a measure of at least one of acceleration, wheel spin, road traction, and skidding.

In an embodiment, the indicia received from the operator control interface is a measure of at least one of desired vehicle direction, desired vehicle acceleration, desired vehicle speed, and mode of vehicle behavior.

In an embodiment, the VCU receives indicia from the energy store and from the operator control interface to determine optimal energy efficiency for each inverter.

In an embodiment, the system also includes: Electronic ABS circuit; Stability Control circuit; Brake force distribution; and a Regenerative braking circuit.

Another aspect of the invention is a modular vehicle control unit which includes a processor coupled to a non-transitory instruction store, which performs a real time operating system (RTOS); a security layer to provide at least one trust zone; an encryption/decryption channel to transmit and receive data and controls over a secure vehicle control network; an energy store management module; an energy store interface; an operator control interface; a sensor interface; and a torque vectoring module.

In an embodiment, the modular vehicle control unit also includes Hydraulic Braking Interface - interface to the hydraulic braking system for monitoring and knowing when engaged.

In an embodiment, the modular vehicle control unit also includes Instrument Display Interface—outputs to the Infotainment display system, covers all systems.

In an embodiment, the modular vehicle control unit also includes Drive Mode Inputs—Settings from the driver on the style of driving and settings.

In an embodiment, the Sensor Interface receives measured Motion, Accelerometers, and wheel spin sensor inputs.

Another aspect of the invention is a secure vehicle control network (SVCN) having: a medium; the medium coupled to, a PHY circuit; the PHY circuit coupled to, a layer 2 real time Ethernet circuit controller; coupled to an encryption/decryption circuit (coder); and, the coder coupled to, a vehicle control unit comprising a processor performing a real time operating system and trust zone layer.

In an embodiment, the secure vehicle control network also has a thin client PHY circuit; the PHY coupled to the medium and to, a thin client Ethernet remote node; and, an encryption/decryption circuit (coder), for connection to at least one client instrument.

### CONCLUSION

The invention can be easily distinguished from conventional vehicle powertrains that have two or three differentials.

The invention can be easily distinguished from conventional vehicle control subsystems that are subject to the inertial mass of its engine, transmission, axels, differentials, and drive shafts.

The invention can be easily distinguished from conventional vehicle personality or performance that are hardware defined.

The invention can be easily distinguished from conventional vehicle handling that may be too crisp or unstable for some drivers and too slow or boat like for other drivers.

The invention can be easily distinguished from conventional vehicle subsystems that depend on distributed control units or microprocessors throughout the vehicle.

The invention can be easily distinguished from conventional vehicle networks and control subsystem that depend on multiple embedded controllers.

The invention can be easily distinguished from conventional vehicle networks and control subsystem which suffer congestion and latency problems as more intelligence is expected in future vehicle designs.

The techniques described herein can be implemented in digital electronic circuitry, or in computer hardware, firmware, software, or in combinations of them. The techniques can be implemented as a computer program product, i.e., a computer program tangibly embodied in a non-transitory information carrier, e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; internal hard disks or removable disks. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used. Accordingly, other embodiments are within the scope of the following claims.

### SEQUENCE LISTING

Not Applicable

1. A system for operation of a vehicle, the system comprising:
at least 4 inverters; each inverter coupled to,
an energy store; the energy store and each inverter further coupled to,
a single vehicle control unit (VCU); the VCU further coupled to both,
an operator control interface circuit; and
a plurality of sensors.

2. The system of claim 1 wherein the VCU is a computer adapted to emit at least one of
a desired torque, and
a desired AC current frequency and magnitude for each inverter by transforming indicia received from at least one sensor and from the operator control interface.

3. The system of claim 2 wherein the indicia received from the at least one sensor is a measure of at least one of acceleration, wheel spin, road traction, and skidding.

4. The system of claim 2 wherein the indicia received from the operator control interface is a measure of at least one of desired vehicle direction, desired vehicle acceleration, desired vehicle speed, and mode of vehicle behavior.

5. The system of claim 2 wherein the VCU receives indicia from the energy store and from the operator control interface to determine optimal energy efficiency for each inverter.

6. The system of claim 2 wherein each of the four or more inverters is a DC to AC converter; each said DC to AC converter coupled to a polyphase electric motor which propels an individual wheel.

7. The system of claim 2 further comprising:
Electronic ABS circuit;
Stability Control circuit;
Brake force distribution; and a
Regenerative braking circuit.

8. The system of claim 2 further comprising:
Drive Mode circuit;
Cooling control circuits;
Hydraulic braking circuit; and an
Instrument display interface

9. A secure vehicle control network (SVCN) comprising:
a signal propagation medium; the medium coupled to,
a PHY circuit; the PHY circuit coupled to,
a layer 2 real time Ethernet circuit controller; coupled to
an encryption/decryption circuit (coder); and, the coder coupled to,
a vehicle control unit comprising a processor performing a real time operating system and trust zone layer.

10. The secure vehicle control network of claim 9 further comprising:
a thin client PHY circuit; the PHY coupled to the medium and to,
a thin client Ethernet remote node; and,
an encryption/decryption circuit (coder), for connection to at least one client instrument.

11. A modular vehicle control unit (VCU) comprising:
a processor coupled to a non-transitory instruction store, which performs
a real time operating system (RTOS);
a security layer to provide at least one trust zone;
an encryption/decryption channel to transmit and receive data and controls over a secure vehicle control network;
an energy store management module;
an energy store interface;
an operator control interface;
a sensor interface; and
a torque-vectoring module.

12. The modular vehicle control unit of claim 11 further comprising:
Regenerative braking—all 4 wheels for regen braking

13. The modular vehicle control unit of claim 11 further comprising:
Brake Force Distribution—Electronic Stability Control in some circles

14. The modular vehicle control unit of claim 11 further comprising:
Electronic ABS—this is the ABS logic for braking that uses the electric motors.

15. The modular vehicle control unit of claim 11 further comprising:
Stability Control—to dampen oscillations due to driver over control.

16. The modular vehicle control unit of claim 11 further comprising: a Cooling Interface that connects to the battery, inverters, and other systems.

17. The modular vehicle control unit of claim 11 further comprising: Hydraulic Braking Interface—interface to the hydraulic braking system for monitoring and knowing when its engaged.

18. The VCU of claim 12 further comprising Instrument Display Interface—outputs to the Infotainment display system, covers all systems.

19. The VCU of claim 11 further comprising Drive Mode Inputs—Settings from the driver on the style of driving and settings.

20. The VCU of claim 11 wherein the Sensor Interface receives measured Motion, Accelerometers, and wheel spin sensor inputs.
